(19) United States
(12) Patent Application Publication
(10) Pub. No.: US 2015/0212991 A1
(43) Pub. Date: Jul. 30, 2015

(54) CONTENT RENDITION GENERATION AND CONTROL

(71) Applicant: Next Issue Media, Menlo Park, CA (US)

(72) Inventors: Keith Barraclough, Mountain View, CA (US); David Irvine, San Jose, CA (US); John Logan, Long Beach, CA (US)

(21) Appl. No.: 14/681,911

(22) Filed: Apr. 8, 2015

Related U.S. Application Data
(63) Continuation-in-part of application No. 14/632,245, filed on Feb. 26, 2015.
Application No. 14/632,245 is a continuation of application No. 13/474,432, filed on May 17, 2012, now Pat. No. 8,977,964.
Application No. 13/474,432 is a continuation-in-part of application No. 13/415,157, filed on Mar. 8, 2012, now Pat. No. 8,978,149.
Application No. 13/474,432 is a continuation-in-part of application No. 13/439,665, filed on Apr. 4, 2012.
Application No. 13/439,665 is a continuation-in-part of application No. 13/415,157, filed on Mar. 8, 2012, now Pat. No. 8,978,149.
(60) Provisional application No. 61/976,939, filed on Apr. 8, 2014.
(60) Provisional application No. 62/093,624, filed on Dec. 18, 2014.
(60) Provisional application No. 61/487,111, filed on May 17, 2011.
(60) Provisional application No. 61/487,111, filed on May 17, 2011.

(51) Int. Cl. G06F 17/22; G06F 17/21

(52) U.S. Cl. CPC G06F 17/2258; G06F 17/212; G06F 17/2247; G06F 17/2235; G06F 17/2288

(57) ABSTRACT

Various aspects of the disclosure are directed to content rendition generation. Sets of disparately-formatted media content are reformatted into corresponding renditions of media content having a common format. The common format includes device-indeterminate ID linking data that links respective portions (e.g., assets or a structural component including the assets) of each rendition with the common format to corresponding portions of the disparately-formatted media content. For each rendition, reformatted assets are generated in which each reformatted is specific to one of a plurality of disparate types of devices, based upon characteristics of the disparate device types. Access to the portions of disparately-formatted media content and/or the assets within the portions of disparately-formatted media content is tracked, based on the linking data.

### FIELD

Various embodiments are directed to content rendition generation and control.

### BACKGROUND

Various devices such as computers, tablets and hand-held devices such as mobile telephones are used at a rapidly increasing pace to access media. For instance, users may access news articles or other stories from a variety of sources.

While access to media has been useful, various aspects remain challenging. For example, article metadata may not be available prior to a publication date for content. In addition, it may be difficult to provide access to disparate types of media content on certain devices, or in a flowing and pleasing format. Often, these issues can hinder the provision of media content, may increase cost for doing so, and otherwise render content access difficult for a variety of uses. These and other matters have presented challenges to content access, for a variety of applications.

### SUMMARY

Various example embodiments are directed to methods and apparatuses involving the generation and implementation of renditions of media content.

In accordance with one or more embodiments, media content is transformed into one or more common formats and stored for subsequent access by remote devices having disparate access characteristics. For providing the content to respective devices, the transformed media content is scaled and formatted for the specific device. In some implementations, different versions are generated for a particular portion/asset of the content, in which each version is tailored to a particular device or device type, with such assets being selected and delivered based upon the type of device. Information in the scaled/formatted data is linked or otherwise related to the transformed media content, and the information can be used for display, tracking and other aspects relating to accessing the content.

The above discussion/summary is not intended to describe each embodiment or every implementation of the present disclosure. The figures and detailed description that follow also exemplify various embodiments.

### DESCRIPTION OF THE FIGURES

Various example embodiments may be more completely understood in consideration of the following detailed description in connection with the accompanying drawings, in which:

FIG. 1 shows a high-level overview of an apparatus and/or method, as may be applicable to systems relating to content consumption, in accordance with one or more example embodiments;

FIG. 2 shows an overview of systems relating to content production, in accordance with one or more embodiments;

FIG. 3 shows a publishing apparatus and approach involving the generation of one or more renditions in a common format, that provides consolidated access to content otherwise provided in a disparate fashion, in accordance with one or more embodiments;

FIG. 4 shows an apparatus and approach with a single rendition having multiple physical assets for each logical asset, providing access to common content via different physical assets amenable to different device characteristics, in accordance with one or more embodiments;

FIG. 5 shows an apparatus and approach with content building, in accordance with one or more embodiments;

FIG. 6 shows a data storage/access apparatus and approach, in accordance with one or more embodiments;

FIG. 7 shows an approach involving the creation of interactive renditions, in accordance with another example embodiment;

FIG. 8 shows a full-text matching procedure as may be carried out with the approach shown in FIG. 7, in accordance with another example embodiment;

FIG. 9 shows an approach involving matching with replica renditions with no article structure, in accordance with another example embodiment;

FIG. 10 shows a system as may be implemented for correlating prior and current record linkage results, in accordance with another example embodiment;

FIG. 11 shows another system as may be implemented for correlating prior and current record linkage results, in accordance with another example embodiment;

FIG. 12 shows an approach for cross-correlation for page matching, in accordance with another embodiment; and

FIG. 13 shows an approach for matching, in accordance with another embodiment.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving media content and related circuits. For instance, in various embodiments, prior and current record linkage results are correlated. A content builder system performs an “article matching” process through a record linkage process that identifies articles within a rendition of content, and correlates each article to article metadata. By correlating multiple renditions to a common set of article metadata, articles can be correlated transitively across renditions, and a “rendition-independent identifier” may be assigned that identifies the set of correlated rendition articles. While not necessarily so limited, various aspects may be appreciated through a discussion of examples using this context.

Some embodiments are directed toward content rendition generation using content that does not have metadata. In this case, substitute article metadata is used, and the content builder system assigns rendition-independent identifiers based on the substitute metadata. The record linkage process can be applied once the publisher-supplied article metadata is available. Accordingly, a record linkage process is implemented, which preserves the original rendition-independent identifiers. In the record linkage process, the content builder system first reads into memory the prior set record linkages between the prior article metadata and the rendition articles. The content builder system then performs the record linkage process using current article metadata and the prior rendition content, producing a current set of record linkages. The prior and current sets of record linkages are then transitively correlated using the local identifiers present in the rendition content, producing a matching between prior and current rendition-independent identifiers. The content builder system applies the prior identifiers to the new record linkage result, thereby correlating the current metadata to the rendition content, while preserving the prior rendition-independent identifiers.

In particular embodiments, fuzzy matching techniques are used to address cases where the correlation of local identifiers is not perfect. For rendition content that uses a replica (e.g., PDF) format, local identifiers are page indices, and the content builder may apply fuzzy matching between two page index sequences to relate the prior and current metadata. For rendition content that uses an interactive (e.g., Folio or OFIP) format, multiple stack local identifiers may constitute an article, and the content builder may apply fuzzy matching between two stack identifier sequences to relate the prior and current metadata.

These and other approaches as characterized herein may be implemented to improve the functionality of article-related features such as promotion of top stories, curated article collections, and full text search. These aspects can be particularly useful in cases where article metadata is not available prior to a publication date for content, or where content is revised such that metadata would be modified. Further, these aspects can improve efficiency and decrease operational costs by reducing editing and correction that may otherwise need to occur when a rendition-independent identifier changes for an article.

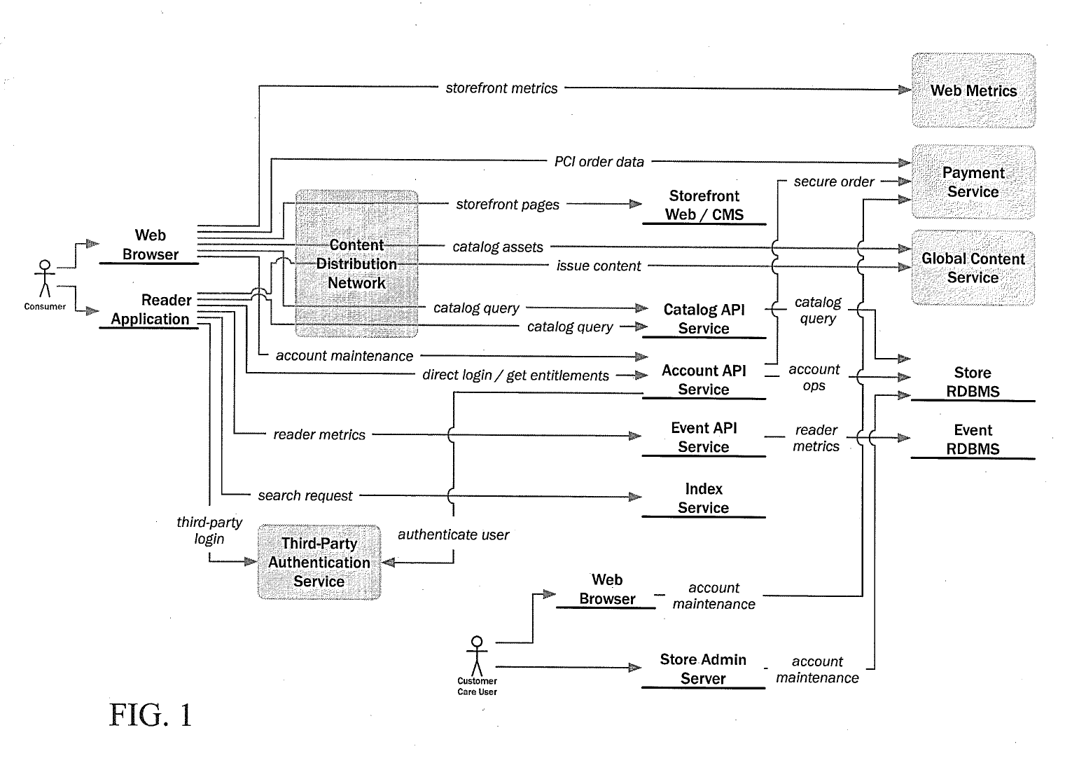

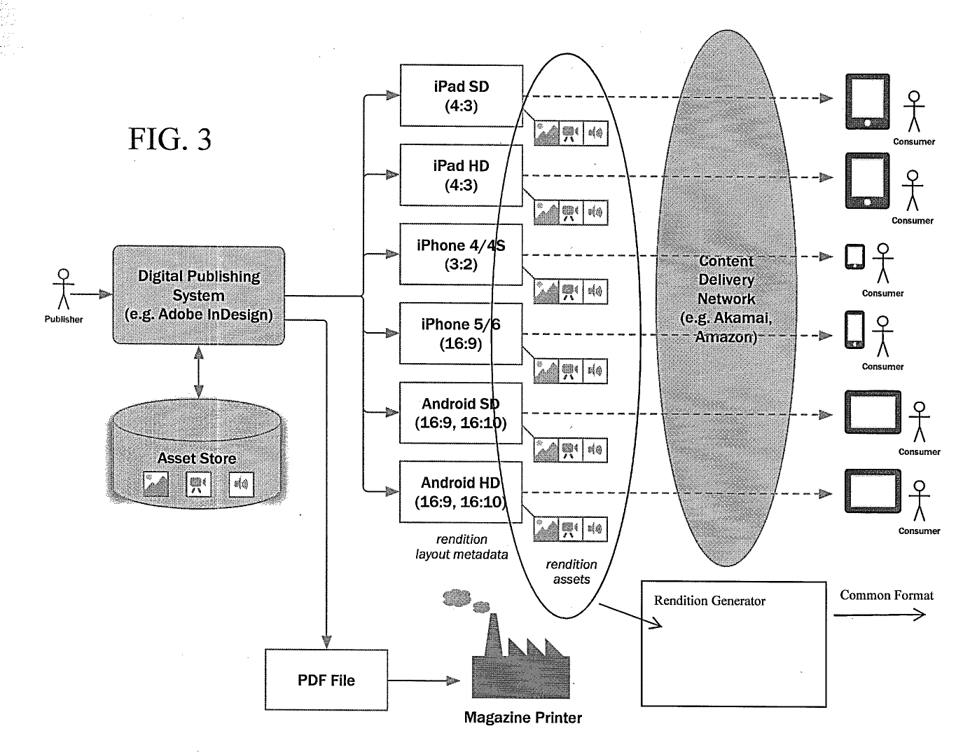

One or more embodiments herein may be implemented in connection with one or more aspects shown and/or described in: U.S. Pat. No. 8,977,964; PCT Publication No. WO 2012/158951; U.S. Pat. No. 8,978,149; and U.S. Patent Publication No. 2012/0297302, all of which are fully incorporated herein by reference. For instance, various rendition-based aspects may be implemented with systems and approaches such as the apparatus shown in FIG. 1 of U.S. U.S. Pat. No. 8,977,964 (e.g., with stored content in one or more renditions) and similar aspects of PCT Publication No. WO 2012/158951. In addition, various embodiments may be implemented with usage-based tracking and content provision as described in U.S. Pat. No. 8,978,149 (e.g., as in FIG. 1). One or more embodiments may also be implemented in connection with content delivery and related presentation of available media (e.g., with creation and management of renditions of that content), such as described in U.S. Patent Publication No. 2012/0297302 (e.g., as shown in and described in connection with FIGS. 1 and 3).

One or more embodiments are directed to a system having a storefront, such as described in U.S. Pat. No. 8,977,964. The storefront may provide a website with catalog-type purchasing functions, such as may be amenable to a magazine rack. Users can select issues, or a library of issues, and may identify what issues a user can access as well as accounting aspects and related user entitlement. Various remote user devices can access the storefront, and a content delivery system provides content to the user devices based upon activity in the storefront (e.g., with content being stored in cloud storage with a content delivery network in front of it using an edge cache).

Various aspects are directed to bringing content into a content delivery network and system, and making content such as a magazine issue available in such a storefront catalog. An input file from a publisher for respective media content includes assets (e.g., media such as text, images and/or video) and metadata that attributes the assets to a page. This information is pushed to a content delivery network, and catalog-related information is pushed to a storefront catalog served by the content delivery network.

Media content received from disparate publishers is formatted into a common format for use and for rapid loading for media-rich content, such as magazine content having embedded video or audio. The common format is transformed into one or more renditions, each rendition including assets (e.g., set of content), which may be presented in two or more formats for each asset. For instance, each format may be device-specific and scaled based upon aspects of the device from which the content is requested for delivery and access (and, e.g., storing). In this context, a single data format/rendition can be used to generate respectively scaled versions of the content that are amenable to use on disparate devices with different requirements, which can be carried out on an asset-by-asset basis. For instance, a rendition can be generated with two or more different versions of respective assets therein, such that the rendition is amenable to access on disparate devices each utilizing a different one of the respective versions. Accordingly, a single rendition can support multiple display resolutions (such as a standard definition and a high-definition display) and image formats (e.g., raster and PDF). For instance, each rendition can be implemented on devices with different display resolutions, aspect ratios, and page layout and the size of the assets that are optimized for each device. Such an approach facilitates rapid load times, and desirable storage of relevant data. In certain embodiments, the common format includes information for loading on remote devices in an order based on which aspects are to be displayed first. In some embodiments, media content is stored with rendition-independent IDs, such that each rendition can be linked to a particular set of content that can be accessed on different devices.

In some embodiments, renditions are made for several target configurations known for particular devices, with the respective configuration stored in a matrix corresponding to a parent set of common format-data. This approach can be implemented, for example, by storing multiple physical assets in a matrix corresponding to logical assets. For instance, for certain high-definition devices, large-scale or high-definition assets corresponding to logical assets of media content may be sent through to end users. For devices operating at lower definition and accessing the same media content, small-scale or low-definition assets corresponding to the same logical assets can be sent to end users. These approaches may, for example, be carried out using a parser function to parse content and identify characteristics such as scaling to be performed based on a size and/or type of assets detected in the content, or other characteristics such as device type or communication connection type.

In addition to scaling as relating to resolution, the format of the respective assets in each rendition, or the format of the renditions themselves, may also be set for the respective devices on which each rendition is to be accessed. For instance, for media content pertaining to a set of assets, metadata that describes aspects of the content such as page layout of magazine-type content is configured with information that models the layout using the different assets. Such an approach can be carried out in various manners, such as by tailoring the resulting scaling and/or format of assets to access and display characteristics and, in some embodiments, characteristics of available delivery channels (e.g., quality of wireless connection via which the content is provided). For instance, some devices may be amenable to displaying certain resolutions of documents formatted in a PDF format available from Adobe, and related assets can be scaled accordingly relative to resolution. For the same target content, devices that do not support such a format may be served by generating another data format type, such as JPEG or PNG, at respective scaling.

Accordingly, different scaled versions of a particular asset, along with information for presentation of content (e.g., display of information, play audio or play video), can be targeted to specific devices. Each asset may contain a series of asset descriptors each of which is a physical asset that has an asset class. Such assets may, for example, be bundled or left unbundled for delivery, such as to group portions of a media content file or portions of different files. For instance, if a page has a video file, such as 10 megabytes, with other aspects in the page being 1-2 megabytes, such a video file can be unbundled from the rest of the page such that the rest of the page can be delivered and displayed first and quickly (e.g., in a single bundled archive that can be retrieved with a single request), with the video being presented later. In some implementations, a place holder or a poster image is displayed in place of the video file until it is delivered and/or until a user requests delivery.

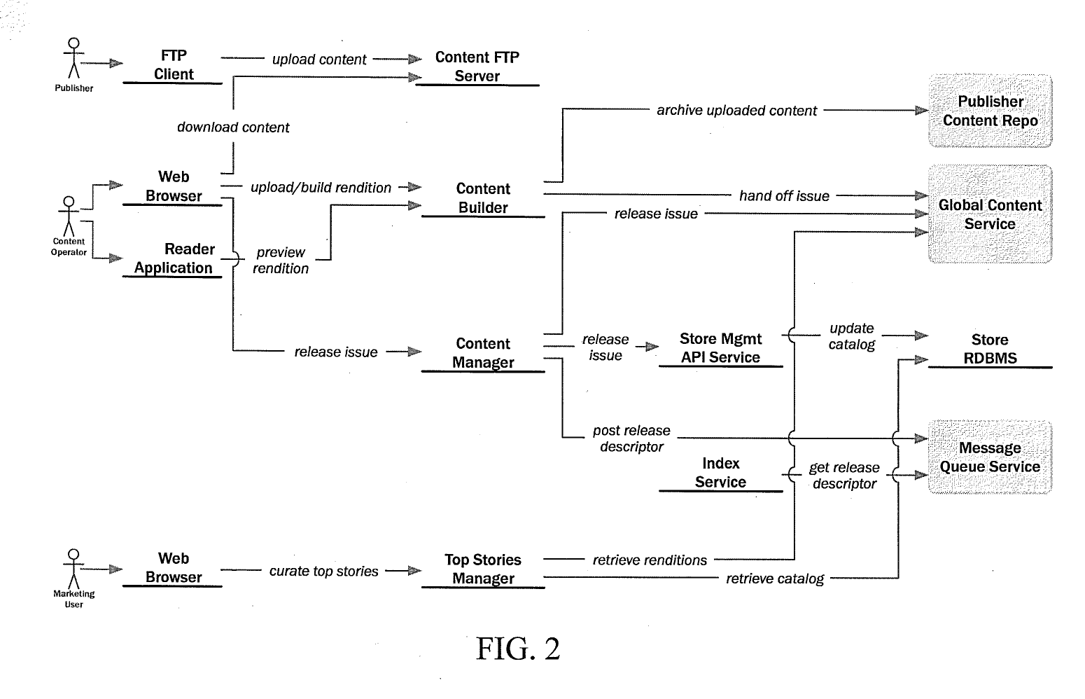

Various embodiments are directed to apparatuses, such as circuitry or circuit modules, that operate to carry out various operations as characterized herein. In a particular embodiment, an apparatus includes a content generation circuit, a content reformatting circuit and a communication circuit. Such components may, for example, be implemented in accordance with those shown in the figures, such as the content builder and content manager in FIG. 2 as may be implemented with generating and formatting a rendition, and with a variety of communication circuits that interface with consumers (e.g., as shown in FIG. 1 and in FIG. 3).

The content generation circuit accesses media content from disparate content providers and in disparate formats, reformats the accessed media content of disparate formats into a common scalable content format that is different than the disparate formats, and stores assets corresponding to an original version of the reformatted media content in association with device-indeterminate metadata that identifies the media content. The content reformatting circuit communicates with a plurality of different types of remote user devices including devices having disparate electronic interface characteristics relating to a format of the media content provided via the device. For each remote device, the content reformatting circuit identifies a format type for that device from one of a plurality of format types for different devices, based on communications with the device. The content reformatting circuit then accesses, for each identified format type, the stored assets corresponding to the original version of the reformatted media content and generates scaled versions of the assets in a format that complies with the identified format type and that includes metadata identifying the media content. The communication circuit communicates each respective scaled asset to a remote device for which the scaled asset has been generated, thereby providing access to the media content of disparate formats at disparate remote devices having disparate electronic interface characteristics, using a single rendition for each set of media content.

In various embodiments, the content reformatting circuit generates each scaled asset by linking the scaled asset back to an identifier for assets in an accessed original version of the content. In response to a request for sharing or otherwise accessing a particular asset at a second remote device having an electronic interface characteristic that relates to a format that is different than a format of available scaled assets, the content reformatting circuit identifies a stored original version of the reformatted media content via the identifier in the particular asset, and generates another scaled asset corresponding to the request, which complies with an identified format type of the second remote device.

In other embodiments in which the media content includes portions that represent pages within the content in which each page has assets corresponding to items displayed via the page, the content reformatting circuit generates different assets for different ones of the disparate electronic interface characteristics. The different assets correspond to a redefined page format suited to the display characteristics of the respective devices, and each page has an identifier that specifies a portion of a stored original version of the reformatted data that corresponds to the page. Using this approach, a user reading a page of media content in a first format on first type of remote device can access articles, pages or assets for that page of media content as included on a different page for a second format and a second different type of remote device, facilitating bookmarking of a page in the media content that the user is accessing on the first type of remote device and subsequent access to bookmarked pages from the second different type of remote device.

Consistent with one or more embodiments, sets of disparately-formatted media content are reformatted into corresponding renditions of media content having a common format. The common format includes device-indeterminate ID linking data that links respective portions of each rendition with the common format to corresponding portions of the disparately-formatted media content. The respective portions include at least one of assets and a structural component of the media content that includes the assets. For each rendition, respective reformatted assets are generated based upon characteristics of one of a plurality of disparate types of devices for which each reformatted asset is specific to. Access to at least one of the portions of the disparately-formatted media content and the assets within the portions of the disparately-formatted media content are tracked, based on the linking data.

The reformatted assets and renditions are generated in a variety of manners. In some implementations, each asset in a particular rendition is scaled and stored in association with metadata that correlates the scaled version with the asset from which it is scaled. This provides multiple versions of each asset for access by respective devices having different display or other characteristics for presenting media content. In other implementations, the reformatted assets are generated in response to a remote user device request for access to a portion of the media content, to form an asset specific to at least one of an operating system, a software application for displaying the media content, and a display size of the remote user device. In some implementations, at least two physical assets are generated for each logical asset pertaining to the rendition, and access to the physical assets is provided via a client module at a remote media content access device. For instance, one of available reformatted physical assets pertaining to a logical asset can be selected based on characteristics of the remote media content access device, and communicated accordingly. In yet other implementations, both navigational data and page layout data are generated for the display of text and/or images for each rendition in association with the assets. In this context, linking data is generated, which links each page in each rendition to at least one article or page in the set of disparately-formatted media content from which the rendition was generated. Further, renditions may be reformatted by at least one of reordering pages, removing pages and inserting pages.

In a more particular embodiment sets of disparately-formatted media digital magazine content are reformatted, with the content being from different sources having disparate digital publication formats and having a format and respective pages upon which text and images are concurrently displayed, into a corresponding set of media content having the common format. Reformatted assets are generated, for one of the sets of media content having a common format, for a rendition having a different arrangement of pages upon which different portions of the text and images are concurrently displayed, relative to the disparately-formatted media content. Linking data is generated to link assets corresponding to text and/or an image from a page in the rendition, with a corresponding at least one of the text or the image on a different page in a corresponding set of disparately-formatted media content.

In various embodiments, a current asset or portion of the media content accessed at a remote user device is tracked. When a user of a remote user device requests access to the same asset from a different remote user device, a new reformatted asset is generated by reformatting an asset in a corresponding one of the sets of disparately-formatted media content according to at least one of an operating system, software application for displaying the media content, and display size of the different remote user device. The reformatted asset is delivered, based on a most recently accessed asset of the media content as indicated via the tracked current asset.

In other embodiments, access to portions or assets as noted above at a remote user device is tracked by communicating, from the remote user device, data corresponding to the linking data and indicative of at least one of an article, text or images that are displayed on the remote user device. The article, text or images are correlated to corresponding text or images in the disparately-formatted media content, and access to a corresponding one of the article, text or images in the disparately-formatted media content is tracked at other remote devices using different reformatted assets. The tracking results are combined to provide an indication of access to the corresponding one of the article, text or images by all of the remote devices.

Linking data as discussed herein may be generated in a variety of manners. In some implementations, the linking data is generated by operating a content recognition engine to automatically match reformatted assets in the renditions with assets in the disparately-formatted media content. Data that links the matched assets is generated, and the assets for each rendition are stored with the generated linking data.

In some implementations, device-indeterminate ID linking data identifies digital media content including at least one of articles, images, text and rich media content displayed on a user device. This identification is independent from the type of device upon which the at least one of images and text is displayed, and independent from a page upon which the digital media content is displayed.

A variety of disparately-formatted content can be processed in accordance with one or more embodiments. In some implementations, the disparately-formatted media content includes respective sets of media content data having different content editing formats that are exclusive to different software-based processing systems, each of which is operable to process content according to protocols specific to the content editing format. The respective sets of disparately-formatted media content are accessed according to the protocols specific to the content editing format of the media content set being accessed. The format of the media content set is reformatted into the common format, such that all of the converted media content sets being accessible using common protocols corresponding to the common format. In certain implementations, the disparately-formatted media content includes respective sets of media content data employing different page-display formats specifying one or more of text location, image location, video location and audio location on respective pages representing the content. The different page-display formats can be modified to provide a common page-display format usable on a plurality of devices.

In some implementations, layout and navigational data is generated for displaying text and/or image content on respective pages, and includes one or more of page layout for the display of text and/or images, page location, navigational information, and linking information that links the text and/or images to other media content. In these contexts, data is generated/reformatted for reproduction on a device having a display type and/or processing system that is different than another device for which the layout and navigational data was generated can be. The layout and navigational data is converted for use with the device for which the generated data is configured, and the converted layout and navigational data is used to generate structural views for the content on the device for which the generated data is configured. This can provide consistent structural views of the content on the device for which the layout and navigational data was generated.

Turning now to the figures, various embodiments are shown and described therein, and may be implemented with one or more embodiments herein. For instance, FIG. 1 shows a high-level overview of an apparatus and/or method, as may be applicable to systems relating to content consumption, in accordance with one or more example embodiments. A storefront Web/CMS interacts with users, with specific content that may be tailored as described herein.

Further, the storefront Web/CMS can also be tailored to operate in accordance with a particular network or location (e.g., tailored to a particular entity offering internet access, and/or to a location at which the service is offered). A content management system can be implemented in this regard, for providing content access based on one or more of the user accessing the content, the content provider, or a provider of services that are used to deliver the content to the user.

Respective application programming interfaces (APIs) can be used to provide cataloging, account services, event services and index services as shown. Resulting information can be stored (e.g., in a relational database management system—RDBMS).

FIG. 2 shows an overview of systems relating to content production, in accordance with one or more embodiments. A content builder module interacts with a content manager module via a global content service. The content builder module transforms content into a format as characterized herein, and delivers the content into a staging area from which the content can be accessed (released), as controlled by the content manager module. These modules may be integrated together.

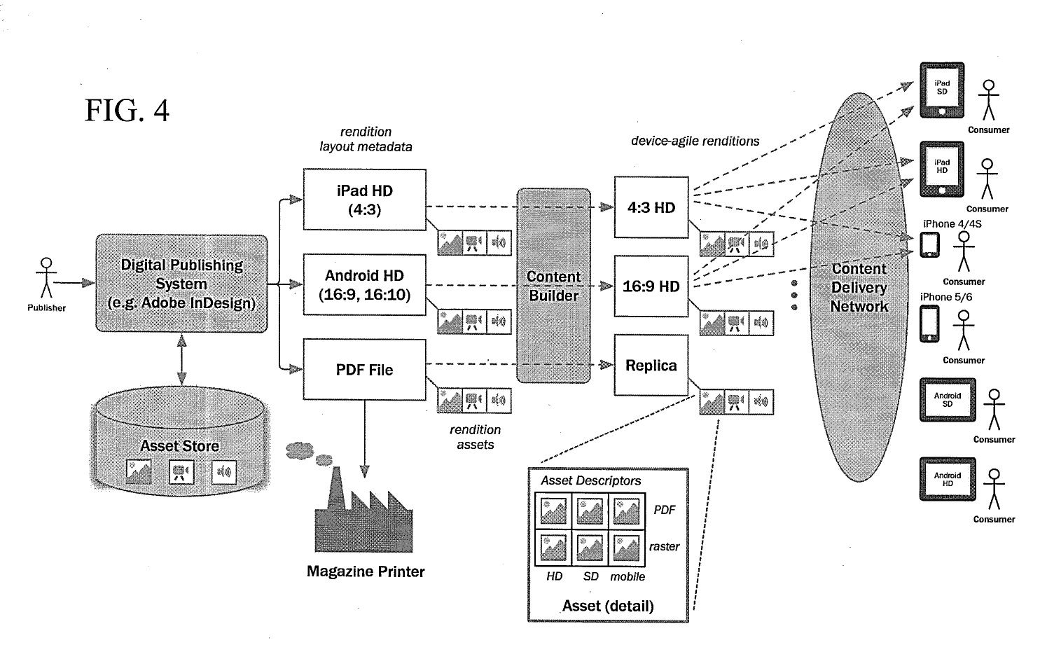

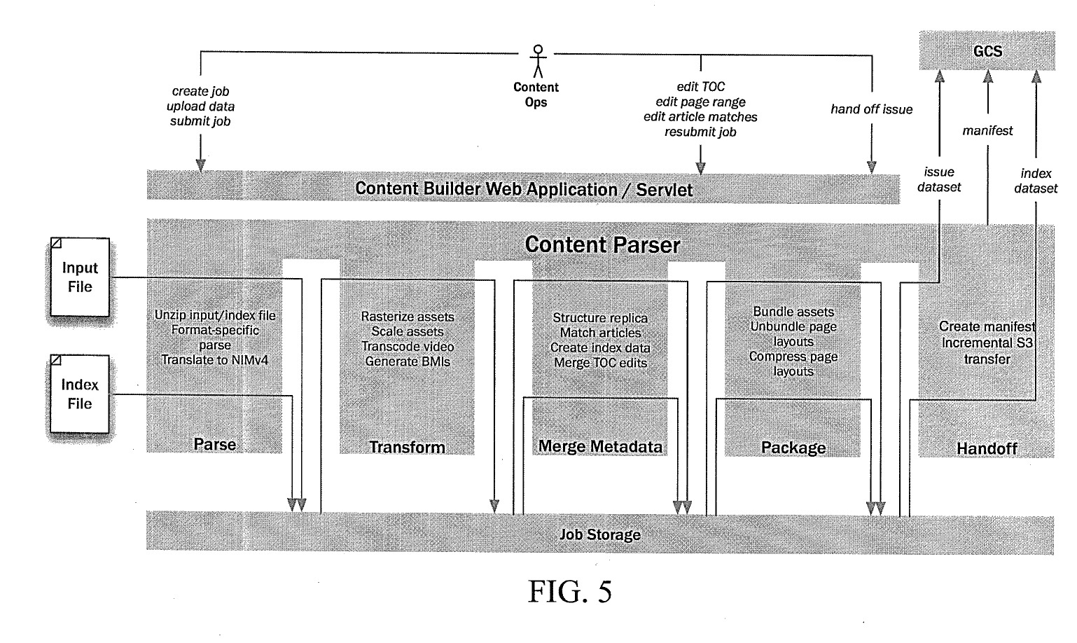

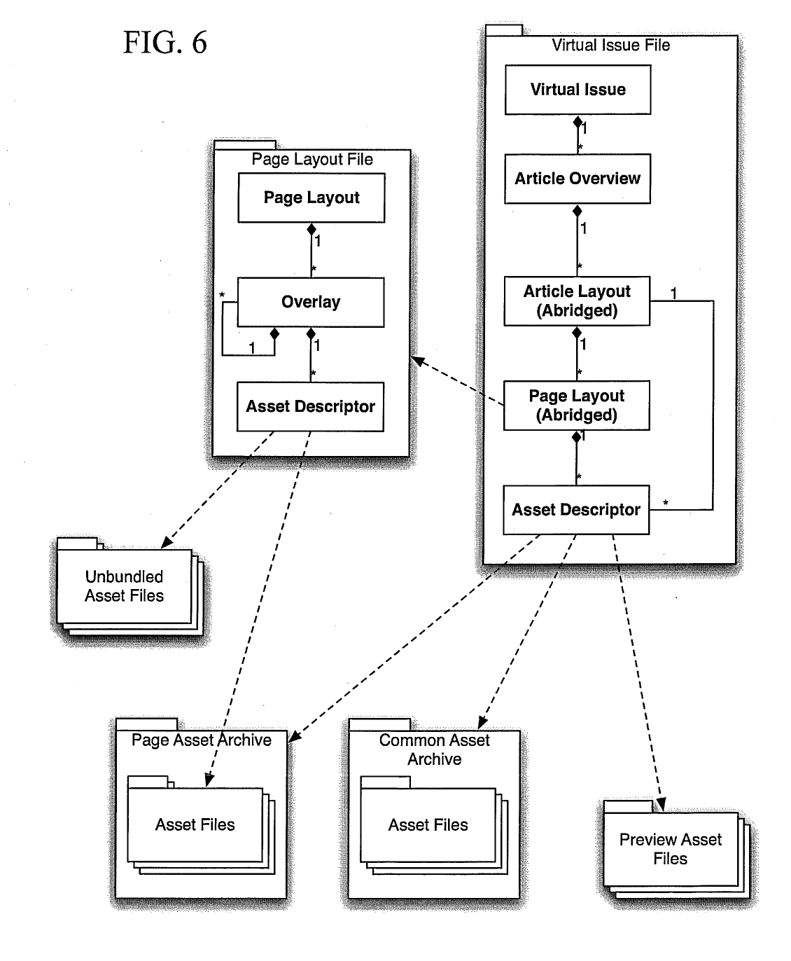

FIG. 3 shows a publishing apparatus and approach involving the generation of one or more renditions in a common format, which provides consolidated access to content otherwise provided in a disparate fashion, in accordance with one or more embodiments. FIG. 4 shows an apparatus and approach with a single rendition having multiple physical assets for each logical asset, providing access to common content via different physical assets amenable to different device characteristics, in accordance with one or more embodiments. FIG. 5 shows an apparatus and approach with content building in accordance with one or more embodiments, and FIG. 6 shows a data storage/access apparatus and approach in accordance with one or more other embodiments.

In some implementations, different content sources for a particular set of media content and related assets are combined and formatted to a common format as discussed herein.

Common index formats are generated and linked relative to metadata, and different source renditions are correlated. For instance, publisher content (e.g., a rendition) for a particular magazine issue that is formatted for a specific user device can be taken in, reformatted into a general high-definition format, and scaled and formatted to provide assets that are accessible by a multitude of disparate types of devices.

In various embodiments, media content is reformatted to account for differences in device and display characteristics, such as aspect ratio and/or differences in display resolution.

In some implementations, media content assets are formatted into separate physical assets for a particular logical asset to maintain certain compatibility, such as that relating to aspect ratio. For instance, separate sets of assets can be made for devices with different aspects ratios or different display sizes. Content can be scaled, such as for display on a large display class (e.g., tablets) or small display class (e.g., hand-held mobile telephones). In certain applications, changes in content may include reflowing text and providing different page layouts.

Various other embodiments tie in data on each rendition to a particular portion of source content, such as articles, sections or other structural components (pages, volumes, chapters, or subsections) that may include assets (e.g., text, images, video, audio, interactive elements) and a structural component of the media content). Content assets and interactive elements may include, for example, images, audio, video, buttons, hyperlinks and pop-ups. For instance, data such as that relating to how users access various magazines, how much time they are spending on certain articles, and which advertisements are viewed can be traced back to source content via mapped content ID. As such, a rendition-dependent article ID can be used in recording data regarding the access to content in the specific rendition, along with a rendition-independent id that maps the rendition back to an original set of media content to provide access information about supported device types. Such an approach may involve, for example, extracting and correlating metadata and other assets, and/or using correlation between respective renditions to track and match access data (e.g., by matching to a table of contents-type correlation of data). In this context, a rendition-independent ID may be mapped to several rendition-specific IDs. A similar approach can be used for tracking access to specific (logical) assets.

Data can be tied in or linked in a variety of manners. In some implementations, an interactive approach for tying or linking data employs both manual matching and automated matching. An initial automated match is carried out using a computer-type circuit to match portions of content from an input file to a new format or rendition, which can be carried out when the input file is transformed. A user can then review the result and correct errors. The new format/rendition is rebuilt using such user-corrected matching directives. In various such approaches involving the transformation of and related matching with publisher-provided input data, publisher-supplied metadata is used as a basis for matching articles across renditions. Publisher metadata is also used to provide article and section structure to renditions that do not naturally have structure, such as a PDF input supplied by publisher. The publisher metadata provides a common reference point between different renditions, and the same metadata can be used for all renditions of an issue.

For certain types of documents such as PDF documents, publisher metadata describing organization of the PDF can be implemented in this regard to generate a table of contents. This can be particularly helpful where such documents are not provided with a table of contents or similar structure. For instance, certain types of documents, such as PDF documents, do not contain information that identifies article structure. For such documents, publisher metadata describing article organization can be implemented in this regard to generate the article-page containment hierarchy and a table of contents. This information can be linked to assets that provide content for each page, such as text, images and/or video.

Using approaches as described herein, usage data for a particular set of media content can be tracked across multiple devices and renditions. For instance, a person browsing a page or otherwise accessing an asset and spending 10 minutes doing so on a first type of tablet and another person spending 15 minutes on the same page or asset in a different format another type of tablet are matched. Such an approach may involve table of content-based matching, other hierarchical matching, and or aspects that relate rendition-specific IDs to rendition-independent

IDs. Certain embodiments involve matching content from different formats using two or more statistical-type approaches.

Accordingly, content from various sources including magazines and others can be linked together and provided via a common format. Content can thus be automatically created, with information in the resulting combination displayed and accessed with related tracking across multiple scaling and format types. Non-homogeneous content from different sources can thus be linked and tracked commonly. For instance, web content or advertisements can be dynamically encapsulated into a common format, and may be mixed with other content such as publisher-based magazine content.

In more specific embodiments, content provided in a general format is reformatted and imparted with navigational and/or page layout metadata data. Such data may include, for example, page layout for the display of text and/or images, and navigational information for these items. The reformatted data (including any relevant assets) is configured and implemented for a device having a display type and/or processing system different than another device for which the layout/navigational data was generated, by converting the layout/navigational data for use with the device for which the reformatted data is configured. The converted data is used to generate structural views for the content on the device for which the reformatted data is configured, which is consistent with structural views of the content on the device for which the layout/navigational data was generated.

For instance, content that is provided in a portable document format (PDF) and having a corresponding initial format for a specific type of device (e.g., for a specific brand of tablet) can be processed to generate content in format that is different than that of the specific type of device but having a layout and navigational information that generally matches that of the initial format. Such PDF content may not have article structure or other metadata associated with it, in which case layout and navigation data is generated to provide a structure that matches that of the initial format, or that does so with scaling applied (e.g., for differently-sized displays). The generated data may thus impart article structure as well as other aspects such as navigational aspects relating to other content.

Accordingly, various embodiments are directed to generating a common content format with a layout and navigation, for multiple different types of received content including content having a format for a specific device, content having article structure without navigation, and content generally format-free such as content in a PDF. The common content format can then be used to generate content for a multitude of different types of devices, which can be implemented to track metadata for the content. Accordingly, a common view and/or navigational structure are provided for access via disparate types of devices. These approaches facilitate user navigation as well as tracking for intermittent access to content and for identifying content access by multiple users. For instance, media content in the form of magazine articles may have different numbers of pages, different layouts, and different renditions. Access to portions of the articles (e.g., pages, or assets) via different types of devices is tracked similarly, to provide an indication of the content accessed independently of the page on which the content is provided or the location on the particular page being viewed.

In some embodiments, magazine data is formatted from original/input data having sections, a collection of articles in each section, and a collection of pages in each article. An index file is created to characterize the magazine, such as to indicate where each article starts in the data. Text can be obtained for each article or page of an incoming article, and broken into subsets of text (e.g., a certain number of words), and the words are processed with a search engine to correlate the text subset with a particular article or page of the incoming article. For instance, certain subsets may span more than one article or page, and a particular page may include text from two or more subsets.

In some implementations, the subsets of text are selected in a manner that facilitates correlation to articles, pages or other components of original documents. For instance, if text is extracted from an original document having a four-page article, subsets of text in the article may be correlated to four different pages in a resulting reformatted media file. In some implementations, page ranges for an article are identified using a search engine approach to match pages of an incoming article to a page range in reformatted media content. As may be consistent with auto-correlating, the page ranges are compared relatively (e.g., as two linear arrays or linear matrixes that can be slid over one other). Once the page ranges are matched (e.g., via a highest page correlation relative to position), the incoming and reformatted content are anchored against each other, and data can be filled in the reformatted version or otherwise adjusted to accommodate mismatches. Further, navigational information can be generated using such matching aspects.

Rendition-independent tracking data is provided and used in a variety of manners to track articles as accessed in various different renditions. In various implementations, data-matching is carried out to identify common content presented in different renditions. One such approach involves the use of a search engine type function as discussed above for text. Other approaches involve the matching of image data. In various contexts, an index of content is created in one domain, and matched to content in another domain using search expressions to find the best match. This information can be used to correlate portions of media content, such as articles. The portions of media content are correlated to a general identification, such as to an index file, that can be used to identify content independently of the end-use format/rendition of that content and the device on which the content is accessed. Such approaches may, for example, be implemented in matching data for media content that has been converted to a common format, back to an original media content file from which the data in the common format has been generated.

These approaches may also be implemented to match different formats of a common set of data within a rendition or in respective renditions of the media content generated from the media content in the common format. Device-independent identification data can thus be assigned to the content in accordance with the common format, with the match (or other linking data) used to correlate content in the renditions back to the media content in the common format. In some implementations, assets may be linked back to content in such an original media content file, generally or specifically. This device-independent data may, for example, link magazine content back to an original magazine article. In various implementations, original media content files used in this context are modified to facilitate searching and matching.

In various embodiments, interactive functions provided in an original media content file are linked to a converted version of the media content file in a common content format. These interactive functions are correlated with related text or imagery as in the original media content file. Similarly, attributes of media content variations, such as high-resolution and low-resolution options as well as high-bandwidth or low-bandwidth (e.g., with lower resolution and/or fewer data-rich components), can be linked back to the original media content. This may, for example, involve linking different physical assets back to a single logical asset. Similarly, different versions of executable code or other interactive components such as web links as implemented on disparate end-user devices can be linked to one another.

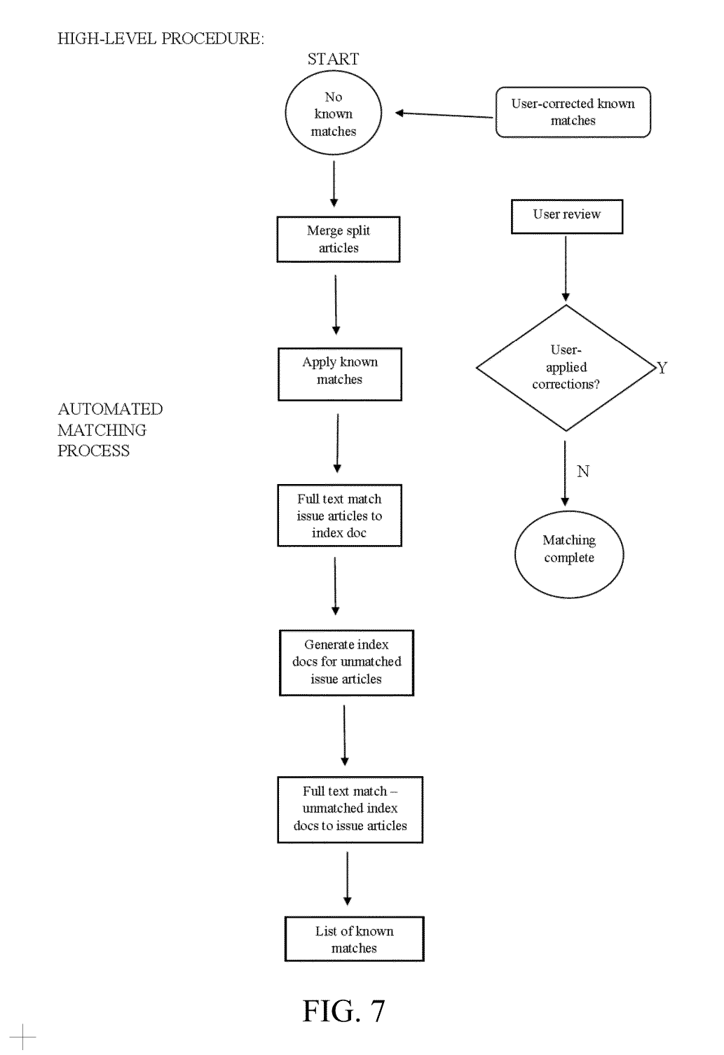

In some embodiments, interactive renditions are created using an article matching approach, using an approach such as shown in FIG. 7. Each article is matched to a particular publisher, with metadata used such that each article has a rendition independent ID.

In various embodiments, linking of text is carried out for articles provided with publisher metadata that includes a collection of index documents, with one index document for each magazine article. Such index documents may, for example, involve publishing requirements for industry standard metadata (PRISM) format XML files. In certain approaches, rendition-independent ID can be computed using a hash function on input data including globally-identifying code for a magazine title, the cover date of the magazine issue and an identifier for the article that is unique within the magazine issue.

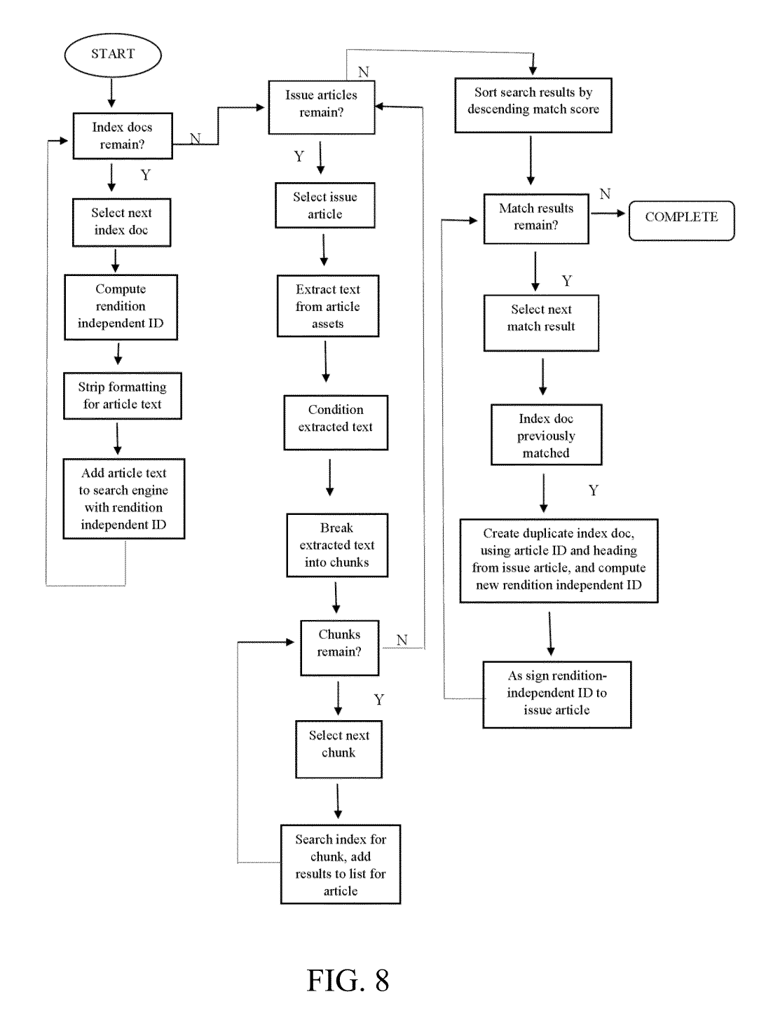

In certain embodiments, a full-text matching procedure is carried out as shown in FIG. 8, for an “issue article to index docs” step of the approach shown in FIG. 7. Where unmatched index documents are linked to issue articles, data is stored in the search index and data is chunked and used in searches.

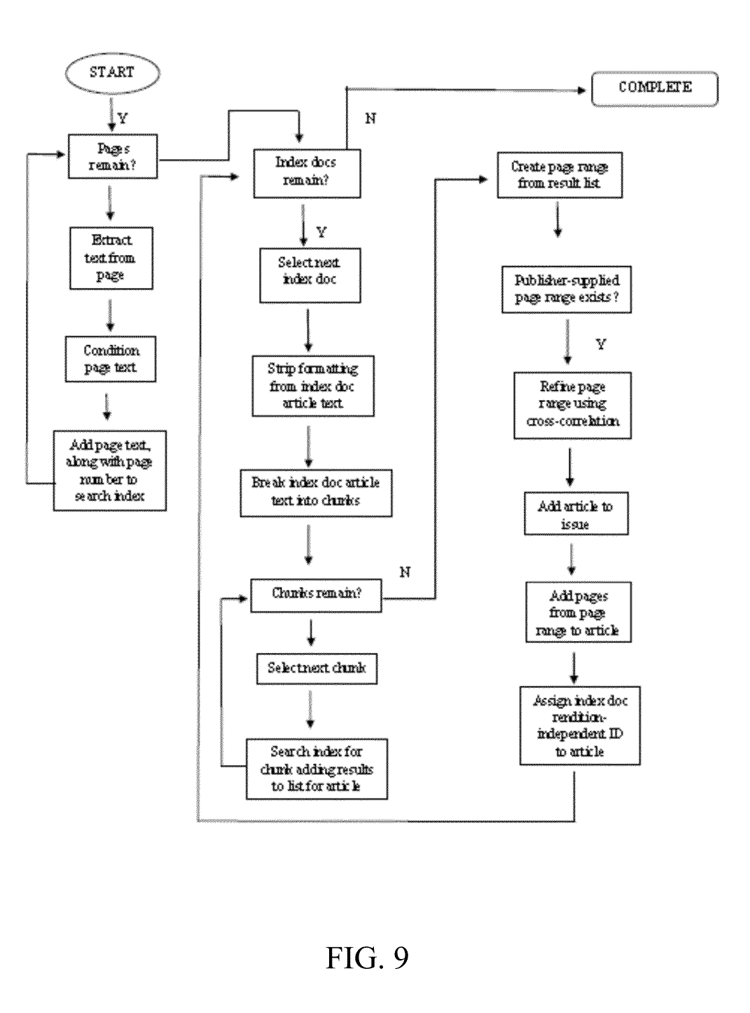

In certain embodiments in which replica renditions such as PDF-based renditions that have no article structure, page matching is carried out as shown in FIG. 9. The article structure is generated using publisher metadata so that table-of-contents navigation can be performed in the reader, and so that articles are correlated by a rendition-independent ID against counterpart articles in other renditions.

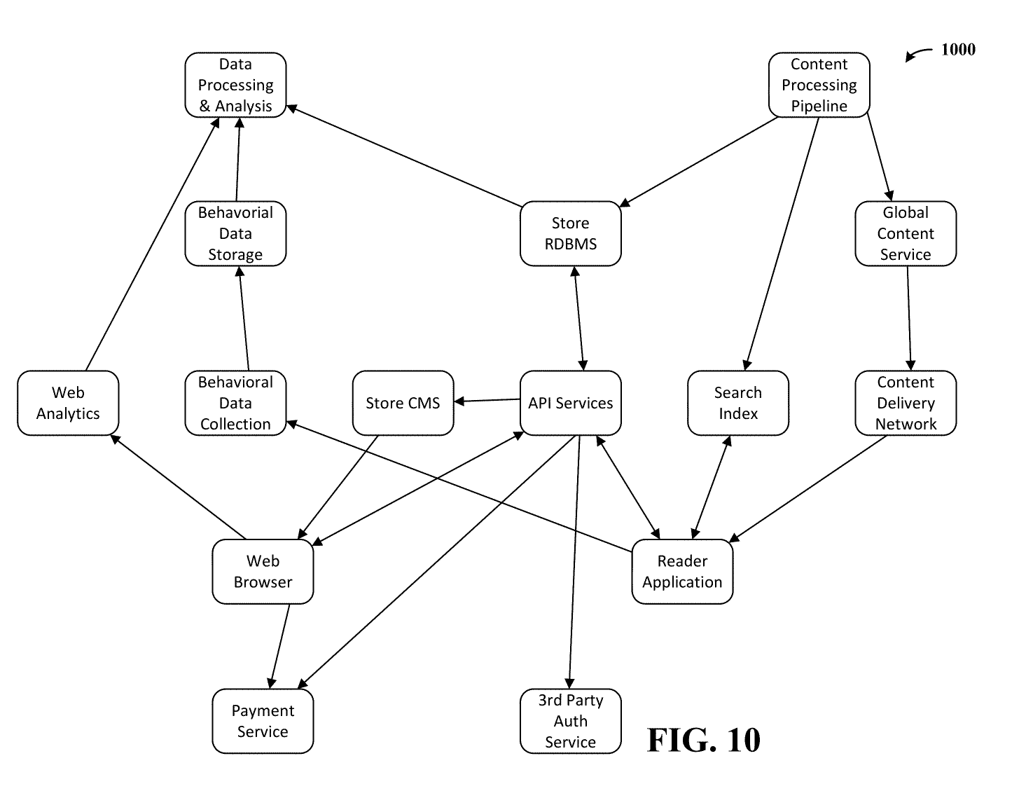

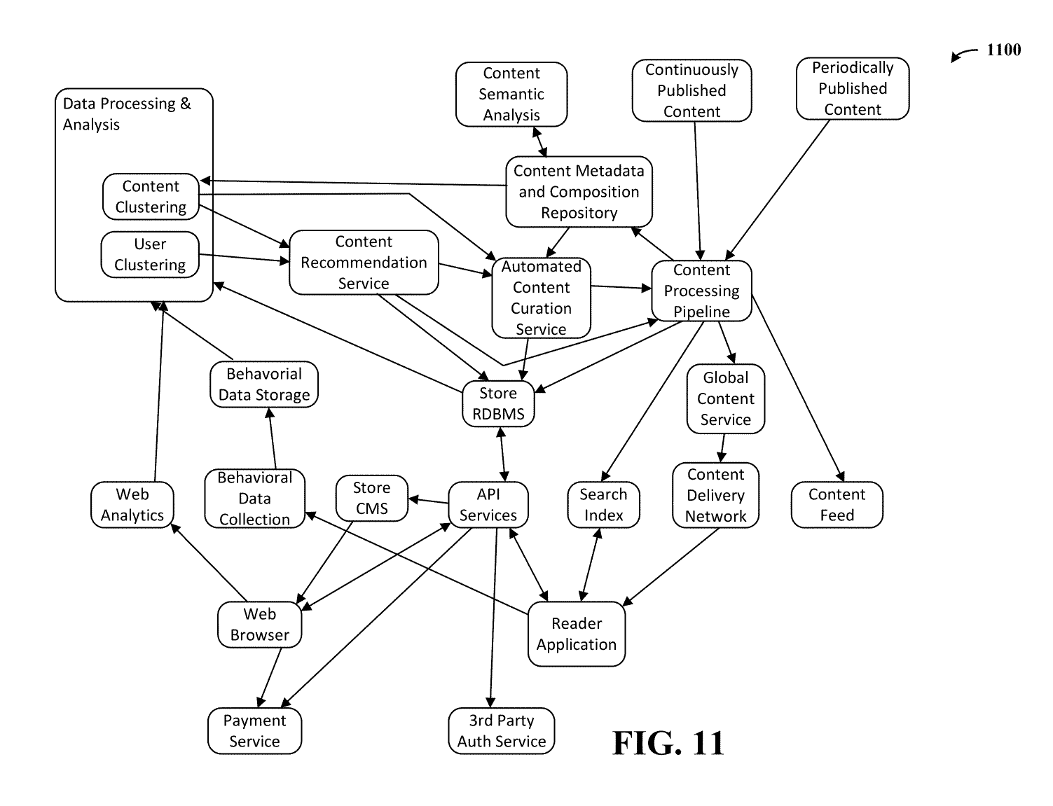

FIG. 10 shows a system 1000 as may be implemented for correlating prior and current record linkage results, in accordance with another example embodiment. FIG. 11 shows yet another system as may be implemented for correlating prior and current record linkage results, in accordance with another example embodiment. Each of the respective components is carried out in accordance with one or more embodiments per the indicated function, as may be consistent with the above.

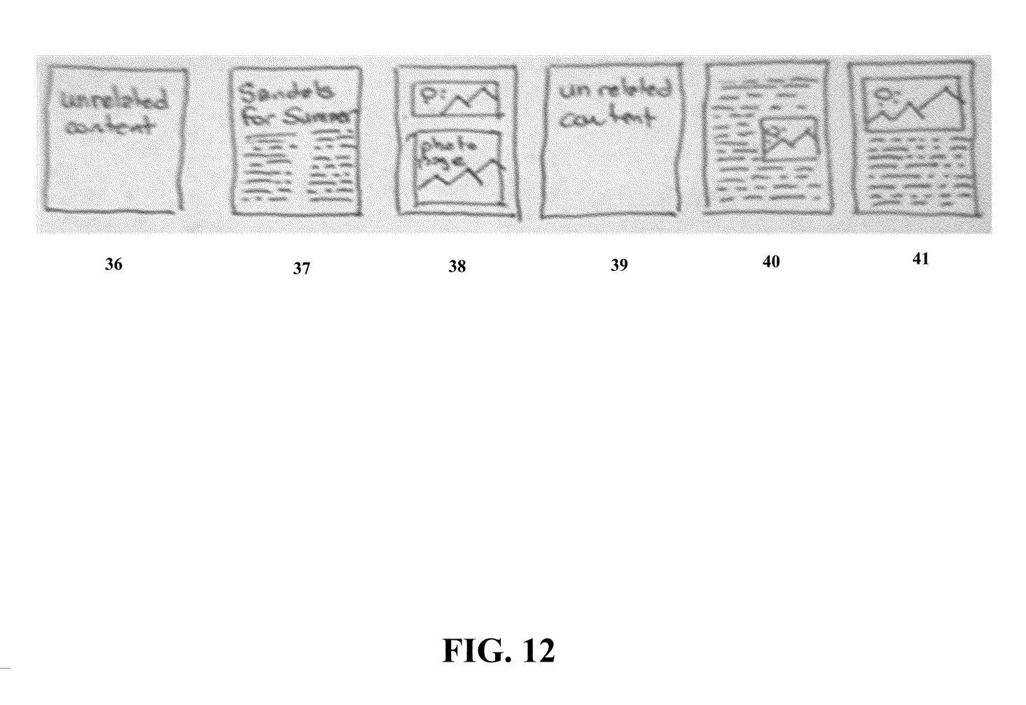

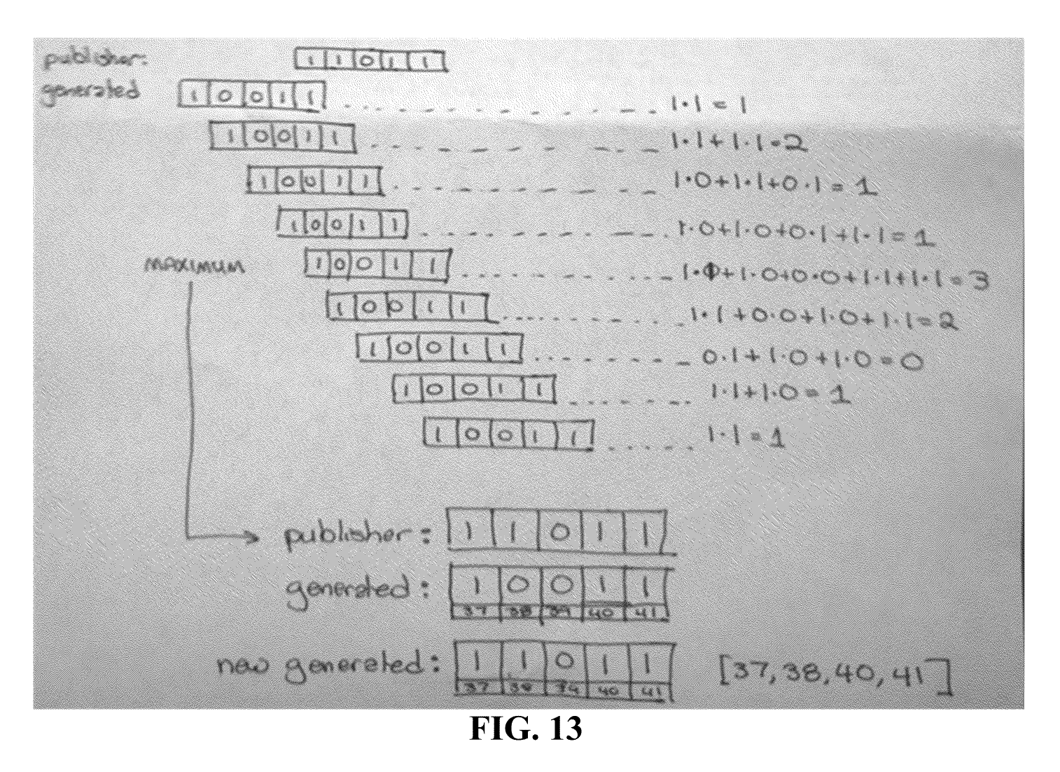

FIG. 12 shows an approach for cross-correlation for page matching, in accordance with another embodiment. Pages in a magazine issue are represented with pages numbers and exemplary content as shown. For an example index document and an article name “Sandals for summer,” a publisher page-range may be: [45,46,48,49], with a generated-page-range: [37,40,41]. FIG. 13 shows an approach for matching, as may use the cross-correlation approach shown in FIG. 12.

In various embodiments, approaches as above are implemented in the context of providing media content access options to a user (e.g., articles in a magazine), with requested articles being reformatted on-the-fly for the user's device from commonly-formatted data as noted. Accordingly, such a magazine includes multiple files that may be presented separately to the user as access is requested, without providing the entire magazine (or, e.g., without providing an entire article).

Various blocks, modules or other circuits may be implemented to carry out one or more of the operations and activities described herein and/or shown in the figures. In these contexts, a “block” (also sometimes “logic circuitry” or “module”) is a circuit that carries out one or more of these or related operations/activities (e.g., the content builder and manager blocks of FIG. 1, or respective content builder, parsing, and other blocks as shown in FIGS. 4-7). For example, in certain of the above-discussed embodiments, one or more modules are discrete logic circuits or programmable logic circuits configured and arranged for implementing these operations/activities, as in the circuit modules shown in FIG. 1 and/or in related aspects as combined with one or more of the recited patent documents herein. In certain embodiments, such a programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions and the second module includes a second CPU hardware circuit with another set of instructions.

Certain embodiments are directed to a computer program product (e.g., nonvolatile memory device), which includes a machine or computer-readable medium having stored thereon instructions which may be executed by a computer (or other electronic device) to perform these operations/activities.

Based upon the above discussion and illustrations, those skilled in the art will readily recognize that various modifications and changes may be made to the various embodiments without strictly following the exemplary embodiments and applications illustrated and described herein. For example, relative aspects of different arrangements of renditions may be combined and used for respective types of devices. In addition, the various embodiments described herein and in the referenced patent documents may be combined in certain embodiments, and various aspects of individual embodiments may be implemented as separate embodiments. Such modifications do not depart from the true spirit and scope of various aspects of the invention, including aspects set forth in the claims.

What is claimed is:

1. A method comprising:
reformatting sets of disparately-formatted media content into corresponding renditions of media content having a common format, the common format including device-indeterminate ID linking data that links respective portions of each rendition with the common format to corresponding portions of the disparately-formatted media content, the respective portions being at least one of assets and a structural component of the media content that includes the assets;
for each rendition, generating respective reformatted assets, each reformatted asset being specific to one of a plurality of disparate types of devices, based upon characteristics of the disparate device types; and
tracking access to at least one of the portions of the disparately-formatted media content and the assets within the portions of the disparately-formatted media content, based on the linking data.

2. The method of claim 1, wherein generating respective reformatted assets includes scaling each of a plurality of assets in a particular rendition in to a scaled version, storing the scaled version of each asset in association with metadata that correlates the scaled version with the asset from which it is scaled, therein providing multiple versions of each asset for access by respective devices having different display or other characteristics for presenting media content.

3. The method of claim 1, wherein:
reformatting the sets of disparately-formatted media content into corresponding sets of media content having a common format includes reformatting digital magazine content, from each of different magazine sources having disparate digital publication formats, having a format and respective pages upon which text and images are concurrently displayed, into a corresponding set of media content having the common format;
generating the respective reformatted assets of the media content includes generating, for one of the sets of media content having a common format, reformatted assets for a rendition having a different arrangement of pages upon which different portions of the text and images are concurrently displayed, relative to the disparately-formatted media content; and
generating the linking data includes generating linking data that links assets corresponding to at least one of text or an image from a page in the rendition, with a corresponding at least one of the text or the image on a different page in a corresponding set of disparately-formatted media content.

4. The method of claim 3, wherein generating the respective reformatted renditions of the media content includes generating renditions of the media content in which pages in the media content are modified by at least one of reordering pages, removing pages and inserting pages.

5. The method of claim 1, wherein generating the respective reformatted assets of the media content includes, in response to a remote user device request for access to a portion of the media content, reformatting an asset of the media content into a reformatted asset that is specific to at least one of an operating system, a software application for displaying the media content, and a display size of the remote user device.

6. The method of claim 1,
wherein tracking the access includes tracking a current asset or portion of the media content accessed at a remote user device, and
further including, in response to a user of the remote user device requesting access to the same asset from a different remote user device:
generating a new reformatted asset by reformatting an asset in a corresponding one of the sets of disparately-formatted media content according to at least one of an operating system, software application for displaying the media content, and display size of the different remote user device, and
delivering the reformatted asset to the different remote user device, based on a most recently accessed asset of the media content as indicated via the tracked current asset.

7. The method of claim 1, wherein tracking access includes:
tracking access to at least one of the portions or assets at a remote user device by communicating, from the remote user device, data corresponding to the linking data and indicative of at least one of an article, text or images that are displayed on the remote user device, and correlating the at least one of an article, text or images to corresponding text or images in the disparately-formatted media content,
tracking access to a corresponding one of the article, text or images in the disparately-formatted media content by other remote devices using different reformatted assets, and
combining the tracking to provide an indication of access to the corresponding one of the article, text or images by all of the remote devices.

8. The method of claim 1, wherein tracking access includes tracking user interactions with the portions or assets.

9. The method of claim 1, wherein generating the reformatted assets includes generating at least two physical assets for each logical asset pertaining to the rendition, further including providing access to the physical assets by, using a client module at a remote media content access device, selecting one of available reformatted physical assets pertaining to a logical asset to be accessed based on characteristics of the remote media content access device, and communicating the selected reformatted physical assets in response to the selecting.

10. The method of claim 1, wherein generating the linking data includes operating a content recognition engine to automatically match reformatted assets in the renditions with assets in the disparately-formatted media content, generating data that links the matched assets, and storing the assets for each rendition with the generated linking data.

11. The method of claim 1, wherein the device-indeterminate ID linking data identifies digital media content including at least one of articles, images, text and rich media content displayed on a user device, independent from the type of device upon which the at least one of images and text is displayed and independent from a page upon which the digital media content is displayed.

12. The method of claim 1, wherein generating the reformatted assets includes generating both navigational data and page layout data for the display of text and/or images for each rendition in association with the assets, and wherein generating the linking data includes generating data that links each page in each rendition to at least one article or page in the set of disparately-formatted media content from which the rendition was generated.

13. The method of claim 1, wherein
the disparately-formatted media content includes respective sets of media content data having different content editing formats that are exclusive to different software-based processing systems, each of which being operable to process content according to protocols specific to the content editing format, and
reformatting the sets of disparately-formatted media content into corresponding renditions of media content having a common format includes accessing the respective sets according to the protocols specific to the content editing format of the media content set being accessed, and converting the format of the media content set into the common format, all of the converted media content sets being accessible using common protocols corresponding to the common format.

14. The method of claim 1, wherein the disparately-formatted media content includes respective sets of media content data employing different page-display formats specifying one or more of text location, image location, video location and audio location on respective pages representing the content, and wherein reformatting the sets of disparately-formatted media content into corresponding renditions having a common format includes modifying the different page-display formats to provide a common page-display format usable on a plurality of devices.

15. The method of claim 1, further including mapping portions of the renditions to portions of reformatted media content and corresponding device-indeterminate ID data, therein providing a link between characteristics of disparate renditions that correspond to a common portion of the reformatted media content.

16. The method of claim 1, wherein reformatting the sets of disparately-formatted media content includes generating layout and navigational data for displaying text and/or image content on respective pages, the generated data including one or more of page layout for the display of text and/or images, page location, navigational information, linking information that links the text and/or images to other media content.

17. The method of claim 16, wherein reformatting the sets of disparately-formatted media content includes generating data for reproduction on a device having a display type and/or processing system that is different than another device for which the layout and navigational data was generated, by converting the layout and navigational data for use with the device for which the generated data is configured and using the converted layout and navigational data to generate structural views for the content on the device for which the generated data is configured, which is consistent with structural views of the content on the device for which the layout and navigational data was generated.

18. An apparatus comprising:
a content generation circuit configured and arranged to
access media content from disparate content providers and in disparate formats,
reformat accessed media content of disparate formats into a common scalable content format that is different than the disparate formats, and
store assets corresponding to an original version of the reformatted media content in association with device-indeterminate metadata that identifies the media content;
a content reformatting circuit configured and arranged to
communicate with a plurality of different types of remote user devices including devices having disparate electronic interface characteristics relating to a format of the media content provided via the device,
for each remote device, identify a format type for that device from one of a plurality of format types for different devices, based on communications with the device,
for each identified format type, access the stored assets corresponding to the original version of the reformatted media content and generate scaled versions of the assets in a format that complies with the identified format type and that includes metadata identifying the media content,
a communication circuit configured and arranged to communicate each respective scaled asset to a remote device for which the scaled asset has been generated, thereby providing access to the media content of disparate formats at disparate remote devices having disparate electronic interface characteristics, using a single rendition for each set of media content.

19. The apparatus of claim 18, wherein the content reformatting circuit is configured and arranged to
generate each scaled asset by linking the scaled asset back to an identifier for assets in an accessed original version of the content, and
in response to a request for sharing or accessing a particular asset at a second remote device having an electronic interface characteristic that relates to a format that is different than a format of available scaled assets,
identify a stored original version of the reformatted media content via the identifier in the particular asset,
generate another scaled asset corresponding to the request, which complies with an identified format type of the second remote device.

20. The apparatus of claim 18, wherein
the media content includes a plurality of portions that represent pages within the content in which each page has assets corresponding to items displayed via the page, and
the content reformatting circuit is configured and arranged to generate different assets for different ones of the disparate electronic interface characteristics, with the different assets corresponding to a redefined page format suited to the display characteristics of the respective devices, and each page having an identifier that specifies a portion of a stored original version of the reformatted data that corresponds to the page,
whereby a user reading a page of media content in a first format on a first type of remote device can access articles, pages or assets for that page of media content as included on a different page for a second format and a second different type of remote device, facilitating bookmarking of a page in the media content that the user is accessing on the first type of remote device and subsequent access to bookmarked pages from the second different type of remote device.
